(19) United States
(12) Patent Application Publication
(10) Pub. No.: US 2026/0362338 A1
(43) Pub. Date: Nov. 12, 2026

(54) COMMUNICATION METHOD AND APPARATUS, TERMINAL, AND STORAGE MEDIUM

(71) Applicant: Beijing Xiaomi Mobile Software Co., Ltd., Beijing (CN)

(72) Inventor: Xiaowei JIANG, Beijing (CN)

(73) Assignee: Beijing Xiaomi Mobile Software Co., Ltd., Beijing (CN)

(21) Appl. No.: 19/515,108

(22) PCT Filed: Aug. 29, 2023
(86) PCT No.: PCT/CN2023/115581

§ 371 Date: Feb. 27, 2026

(51) Int. Cl. H04W 52/02

(52) U.S. Cl. CPC H04W 52/0245; H04W 52/0254

(57) ABSTRACT

Embodiments of the present disclosure provide a communication method and apparatus, a terminal, and a storage medium. The method includes: after a first receiver of the terminal enters or exits a first state, performing a first operation for the first receiver according to a first type condition. The first state is a sleep state of the first receiver. The first type condition includes at least one of: a condition in which a determination is made based on a retention duration, a condition in which a determination is made based on a signal quality, or a condition in which a determination is made based on a movement speed of the terminal. The first operation comprise one of: entering the first state or exiting the first state.

### CROSS REFERENCE TO RELATED APPLICATION

The present application is a U.S. National Stage of International Application No. PCT/CN2023/115581, filed on Aug. 29, 2023, the contents of which are incorporated herein by reference in its entirety.

### TECHNICAL FIELD

The present disclosure relates to the communication technical field, and in particular to a communication method, a terminal, and apparatus and a storage medium.

### BACKGROUND

In the communication technical field, in order to achieve energy saving for a terminal, a Low Power Wake Up Receiver (LP-WUR), also known as a Low Power Receiver (LR), has been introduced. When a base station sends a Low Power Wake Up Signal (LP-WUS) to a terminal to wake up the terminal with a main receiver in sleep, the main receiver of the terminal is in sleep at this time, and the terminal uses the LP-WUR to receive the LP-WUS. After receiving the LP-WUS, the main receiver of the terminal can be woken up for data transmission and reception operations, etc. The power consumption of the LP-WUR of the terminal is much lower than that of the main receiver of the terminal. Additionally, a Low Power Synchronization Signals (LP-SS) has also been introduced.

### SUMMARY

Embodiments of the present disclosure provide a communication method, a terminal, an apparatus and a storage medium.

According to a first aspect of an embodiment of the present disclosure, a communication method is provided. The method is performed by a terminal. The method includes:
after a first receiver of the terminal enters or exits a first state, performing a first operation for the first receiver according to a first type condition;
where the first state is a sleep state of the first receiver;
where the first type condition includes at least one of: a condition in which a determination is made based on a retention duration; a condition in which a determination is made based on a signal quality; or a condition in which a determination is made based on a movement speed of the terminal;
where the first operation includes one of: entering the first state or exiting the first state.

According to a second aspect of an embodiment the present disclosure, a terminal is provided. The terminal includes:
a processing module configured to:
after a first receiver of the terminal enters or exits a first state, perform a first operation on the first receiver according to a first type condition;
wherein the first state is a sleep state of the first receiver;
where the first type condition includes at least one of: a condition in which a determination is made based on a retention duration; a condition in which a determination is made based on a signal quality; or a condition in which a determination is made based on a movement speed of the terminal;
where the first operation includes one of: entering the first state or exiting the first state.

According to a third aspect of an embodiment of the present disclosure, a communication apparatus is provided. The communication apparatus includes:
a memory including executable instructions;
one or more processors;
where when the executable instruction are executed by the processors, the communication apparatus is caused to perform the communication method provided in the first aspect.

According to a fourth aspect of an embodiment of the present disclosure, a storage medium is provided. The storage medium stores instructions. When the instructions run on a communication device, the communication device is caused to perform the communication method provided in the first aspect.

The technical solutions provided by the embodiment of the present disclosure can realize a communication mechanism adapted to the introduction of the low power receiver.

It should be understood that the above general description and the following detailed description are example and explanatory only, and are not intended to limit the embodiments of the present disclosure.

### BRIEF DESCRIPTION OF THE DRAWINGS

The accompanying drawings, which are incorporated in and form a part of the specification, illustrate embodiments consistent with the present disclosure, and together with the specification, serve to explain principles of the embodiments of the present disclosure.

FIG. 1a is a schematic diagram of an architecture of a communication system according to an example embodiment;

FIG. 1b is a schematic diagram of an architecture of a communication system according to an example embodiment;

FIG. 2 is a schematic flowchart of a communication method according to an example embodiment;

FIG. 3a is a schematic flowchart of a communication method according to an example embodiment;

FIG. 3b is a schematic flowchart of a communication method according to an example embodiment;

FIG. 4a is a schematic flowchart of a communication method according to an example embodiment;

FIG. 4b is a schematic flowchart of a communication method according to an example embodiment;

FIG. 5 is a schematic flowchart of a communication method according to an example embodiment;

FIG. 6a is a schematic diagram of a structure of a network device according to an example embodiment;

FIG. 6b is a schematic diagram of a structure of a terminal according to an example embodiment;

FIG. 7a is a schematic diagram of a structure of a UE according to an example embodiment;

FIG. 7b is a schematic diagram of a structure of a communication device according to an example embodiment.

### DETAILED DESCRIPTION

With the introduction of the low power receiver, the operation of the main receiver is a problem that needs to be considered.

Embodiments of the present disclosure provide a communication method, a terminal, an apparatus, and a storage medium.

In a first aspect, an embodiment of the present disclosure provides a communication method. The method is performed by a terminal. The method includes:
after a first receiver of the terminal enters or exits a first state, performing a first operation for the first receiver according to a first type condition;
where the first state is a sleep state of the first receiver;
where the first type condition includes at least one of: a condition in which a determination is made based on a retention duration; a condition in which a determination is made based on a signal quality; a condition in which a determination is made based on a movement speed of the terminal;
where the first operation includes one of: entering the first state or exiting the first state.

The technical solutions provided by the embodiment of the present disclosure can realize a communication mechanism adapted to the introduction of the low power receiver.

In the above embodiment, after the first receiver of the terminal enters or exits the first state, the first operation is performed for the first receiver according to the first type condition. That is, the first operation is performed after retention of a state for a period of time, and/or the first operation is performed according to the condition in which a determination is made based on the signal quality, and/or the first operation is performed according to the condition in which a determination is made based on the movement speed of the terminal. Compared with a case of immediately performing the first operation, frequent ping-pong switching can be reduced, energy consumption can be reduced, and the battery life of the terminal can be extended.

In conjunction with some embodiments of the first aspect, before performing the first operation for the first receiver according to the first type condition, the method further includes:
determining whether the first receiver enters or exits the first state according to a second type condition;
where the second type condition includes at least one of:
a condition in which a determination is made based on a signal quality;
a condition in which a determination is made based on the movement speed of the terminal.

In the above embodiment, whether the first receiver enters or exits the first state can be determined based on the signal quality and/or the movement speed of the terminal, making the determination method more flexible.

In conjunction with some embodiments of the first aspect, performing the first operation for the first receiver according to the first type condition includes: enabling the first receiver to exit the first state after the first receiver maintains the first state for at least a first duration after entering the first state; or
performing the first operation for the first receiver according to the first type condition includes: enabling the first receiver to enter the first state after the first receiver maintains out of the first state for at least a second duration after exiting the first state.

In the above embodiment, after the first receiver enters the first state, the first receiver can exit the first state after maintaining it for at least the first duration, or after the first receiver exits the first state, the first receiver can enter the first state after maintaining out of the first state for at least the second duration, without immediately performing the first operation. In this way, ping-pong switching can be reduced.

In conjunction with some embodiments of the first aspect, enabling the first receiver to exit the first state after the first receiver maintains for at least the first duration after entering the first state includes:
after the first receiver enters the first state, maintaining the first state for at least the first duration, and determining that a signal quality of a reference signal received by the terminal is less than or equal to a first signal quality threshold, exiting the first state; or
after the first receiver enters the first state, maintaining the first state for at least the first duration, and determining that a sum of the signal quality of the reference signal received by the terminal and a first hysteresis is less than or equal to the first signal quality threshold, exiting the first state.

In the above embodiment, the first receiver can exit the first state after maintaining the first state for the first duration and the signal quality meets the requirement, which can reduce ping-pong switching.

In conjunction with some embodiments of the first aspect, enabling the first receiver to enter the first state after the first receiver maintains out of the first state for at least the second duration after exiting the first state includes:
after the first receiver exits the first state, maintaining out of the first state for at least the second duration, and determining that the signal quality of the reference signal received by the terminal is greater than or equal to a second signal quality threshold, entering the first state; or
after the first receiver exits the first state, maintaining out of the first state for at least the second duration, and determining that a difference between the signal quality of the reference signal received by the terminal and a second hysteresis is greater than or equal to the second signal quality threshold, entering the first state.

In the above embodiment, the first receiver can enter the first state after maintaining for the first duration and the signal quality meets the requirement, which can reduce ping-pong switching.

In conjunction with some embodiments of the first aspect, the method further includes:
based on a predetermined communication rule and/or received first information, determining at least one of: the first duration, the first signal quality threshold, the first hysteresis, the second duration, the second signal quality threshold, the second hysteresis, and the first period.

In the above embodiment, at least one of the first duration, the first signal quality threshold, the first hysteresis, the second duration, the second signal quality threshold, the second hysteresis and the first period can be determined based on the predetermined communication rule and/or the first information, allowing for more flexible configuration.

In conjunction with some embodiments of the first aspect, performing the first operation for the first receiver according to the first type condition includes:
after the first receiver enters the first state, within a third duration, determining that the signal quality of the reference signal received by the terminal is less than or equal to a third signal quality threshold, exiting the first state; or
after the first receiver enters the first state, within the third duration, determining that a sum of the signal quality of the reference signal received by the terminal and a third hysteresis is less than or equal to the third signal quality threshold, exiting the first state.

In the above embodiment, by setting a higher third signal quality threshold, the first receiver is less likely to exit the first state within the third duration, which can reduce ping-pong switching.

In conjunction with some embodiments of the first aspect, performing the first operation for the first receiver according to the first type condition includes:
after the first receiver enters the first state, maintaining state unchanged after the third duration; determining that the signal quality of the reference signal received by the terminal is less than or equal to a fourth signal quality threshold, exiting the first state; or
after the first receiver enters the first state, maintaining the state unchanged after the third duration; determining that a sum of the signal quality of the reference signal received by the terminal and a fourth hysteresis is less than or equal to the fourth signal quality threshold, exiting the first state.

In the above embodiments, the first receiver can be allowed to exit the first state normally by adjusting the fourth signal quality threshold.

In conjunction with some embodiments of the first aspect, the third signal quality threshold and the fourth signal quality threshold are different; and/or, values of the third hysteresis and the fourth hysteresis are different.

In the above embodiment, since the third signal quality threshold and the fourth signal quality threshold are different; and/or the values of the third hysteresis and the fourth hysteresis are different, a mechanism for the first receiver to enter or exit the first state can be flexibly implemented.

In conjunction with some embodiments of the first aspect, performing the first operation for the first receiver according to the first type condition includes:
after the first receiver exits the first state, within a fourth duration, determining that the signal quality of the reference signal received by the terminal is greater than or equal to a fifth signal quality threshold, entering the first state; or
after the first receiver exits the first state, within the fourth duration, determining that a difference between the signal quality of the reference signal received by the terminal and a fifth hysteresis is greater than or equal to the fifth signal quality threshold, entering the first state.

In the above embodiment, by setting a higher fifth signal quality threshold, the first receiver is less likely to enter the first state within the fourth duration, which can reduce ping-pong switching.

In conjunction with some embodiments of the first aspect, performing the first operation for the first receiver according to the first type condition includes:
after the first receiver exits the first state, maintaining the state unchanged after the fourth duration; determining that the signal quality of the reference signal received by the terminal is greater than or equal to a sixth signal quality threshold, entering the first state; or
after the first receiver exits the first state, maintaining the state unchanged after the fourth duration; determining that a difference between the signal quality of the reference signal received by the terminal and a sixth hysteresis is greater than or equal to the sixth signal quality threshold, entering the first state.

In the above embodiment, the first receiver can be allowed to enter the first state normally by setting the sixth signal quality threshold.

In conjunction with some embodiments of the first aspect, the fifth signal quality threshold and the sixth signal threshold are different; and/or, values of the fifth hysteresis and the sixth hysteresis are different.

In the above embodiment, since the fifth signal quality threshold and the sixth signal quality threshold are different; and/or the values of the fifth hysteresis and the sixth hysteresis are different, a mechanism for the first receiver to enter or exit the first state can be flexibly implemented.

In conjunction with some embodiments of the first aspect, the method further includes:
based on a predetermined communication rule and/or received second information, determining at least one of: the third duration, the third signal quality threshold, the third hysteresis, the fourth signal quality threshold, the fourth hysteresis, the fourth duration, the fifth signal quality threshold, the fifth hysteresis, the sixth signal quality threshold, and the sixth hysteresis.

In the above embodiments, in conjunction with some embodiments of the first aspect described above, the method further includes:
determining at least one of the third duration, the third signal quality threshold, the third hysteresis, the fourth signal quality threshold, the fourth hysteresis, the fourth duration, the fifth signal quality threshold, the fifth hysteresis, the sixth signal quality threshold, and the sixth hysteresis based on the predetermined communication rule and/or the received second information. More flexible configuration is allowed.

In conjunction with some embodiments of the first aspect, performing the first operation for the first receiver according to the first type condition includes:
after the first receiver enters the first state, within a fifth duration, determining that the movement speed of the terminal is greater than or equal to a first speed threshold, exiting the first state; or
after the first receiver enters the first state, within the fifth duration, determining that a difference between the movement speed of the terminal and a first offset value is greater than or equal to the first speed threshold, exiting the first state.

In the above embodiment, the first speed threshold can be set to make it less likely for the first receiver to exit the first state within the fifth duration, thereby reducing ping-pong switching.

In conjunction with some embodiments of the first aspect, performing the first operation for the first receiver according to the first type condition includes:
after the first receiver enters the first state, maintaining the state unchanged after the fifth duration; determining that the movement speed of the terminal greater than or equal to a second speed threshold, exiting the first state; or
after the first receiver enters the first state, maintaining the state unchanged after the fifth duration; determining that a difference between the movement speed of the terminal and a second offset value is greater than or equal to the second speed threshold, exiting the first state.

In the above embodiment, the first receiver can be allowed to exit the first state normally by setting the second speed threshold.

In conjunction with some embodiments of the first aspect, the first speed threshold and the second threshold are different; and/or, the first offset value and the second offset value are different.

In the above embodiment, since the first speed threshold and the second threshold are different; and/or the first offset value and the second offset value are different, a mechanism for the first receiver to enter or exit the first state can be flexibly implemented.

In conjunction with some embodiments of the first aspect, performing the first operation for the first receiver according to the first type condition includes:
after the first receiver exits the first state, within a sixth duration, determining that the movement speed of the terminal is less than or equal to a third speed threshold, entering the first state; or
after the first receiver exits the first state, within the sixth duration, determining that a sum of the movement speed of the terminal and a third offset value is less than or equal to the third speed threshold, entering the first state.

In the above embodiment, the third speed threshold can be set to make it less likely for the first receiver to enter the first state within the sixth duration, thereby reducing ping-pong switching.

In conjunction with some embodiments of the first aspect, performing the first operation for the first receiver according to the first type condition includes:
after the first receiver exits the first state, maintaining the state unchanged after the sixth duration; determining that the movement speed of the terminal is less than or equal to a fourth speed threshold, entering the first state; or
after the first receiver exits the first state, maintaining the state unchanged after the sixth duration; determining that a sum of the movement speed of the terminal and a fourth offset value is less than or equal to the fourth speed threshold, entering the first state.

In the above embodiment, the first receiver can be allowed to enter the first state normally by setting the fourth speed threshold.

In conjunction with some embodiments of the first aspect, the third speed threshold and the fourth speed threshold are different; and/or, the third offset value and the fourth offset value are different.

In the above embodiment, since the third speed threshold and the fourth speed threshold are different, and/or the third offset value and the fourth offset value are different, a mechanism for the first receiver to enter or exit the first state can be flexibly implemented.

In conjunction with some embodiments of the first aspect, the method further includes:
based on a predetermined communication rule and/or received third information, determining at least one of: the fifth duration, the first speed threshold, the first offset value, the second speed threshold, the second offset value, the sixth duration, the third speed threshold, the third offset value, the fourth speed threshold, and the fourth offset value.

In the above embodiment, at least one of the fifth duration, the first speed threshold, the first offset value, the second speed threshold, the second offset value, the sixth duration, the third speed threshold, the third offset value, the fourth speed threshold, and the fourth offset value can be determined based on the predetermined communication rule and/or the received third information, allowing for more flexible configuration.

In conjunction with some embodiments of the first aspect, the method further includes:
if the number of times of entering and exiting the first state within a first period is greater than or equal to a first quantity, increasing a predetermined duration;
where the predetermined duration includes at least one of: the first duration, the second duration, the third duration, the fourth duration, the fifth duration, and the sixth duration.

In the above embodiment, when entering and exiting the first state frequently, the switching frequency can be adjusted by adjusting the predetermined duration(s).

In conjunction with some embodiments of the first aspect, the method further includes:
the first receiver being not in the first state, performing a second operation;
or, the first receiver being in the first state, stopping performing the second operation or turning off an active device;
where the second operation includes at least one of:
monitoring a downlink (DL) channel;
receiving a downlink (DL) channel;
sending an uplink (UL) signal;
sending uplink (UL) data.

In the above embodiment, the second operation and the operation of turning off the active device are clearly defined.

In the above embodiments, the reference signal is one of:
a first signal that is a signal received by the first receiver;
a second signal that is a signal received by a second receiver.

In conjunction with some embodiments of the first aspect, the method further includes:
receiving fourth information sent by a network device;
where the fourth information indicates that the reference signal is the first signal or the second signal.

In the above embodiment, whether the reference signal is the first signal or the second signal can be explicitly indicated.

In conjunction with some embodiments of the first aspect, the first signal is a synchronization signal block SSB; the second signal is a Low Power Synchronization Signal (LP-SS).

In conjunction with some embodiments of the first aspect, the method further includes:
receiving the fifth information sent by the network device;
where the fifth information includes at least one of: LP-SS configuration information; LP-WUS configuration information.

In conjunction with some embodiments of the first aspect, receiving the fifth information sent by the network device includes:
receiving a system message sent by the network device, where the system message includes the fifth information.

In conjunction with some embodiments of the first aspect, the fifth information includes at least one of:
information about a Frequency Range (FR);
duty cycle information for monitoring the LP-WUS;
a time-domain resource and/or a frequency-domain resource for monitoring the LP-WUS;
a scramble code for addressing the terminal;
a validity area or a timer for the LP-WUS configuration;
a specific Radio Network Temporary Identifier (RNTI) for LP-WUS activation or deactivation;
a waveform for the LP-WUS;
configuration information for beam sweeping for LP-WUS transmission;
a frequency offset between the first and second receivers of the terminal;
a downlink (DL) timing offset between the first receiver and the second receiver.

In a second aspect, an embodiment of the present disclosure provides a terminal. The terminal includes:
a processing module configured to:
after a first receiver of the terminal enters or exits a first state, perform a first operation for the first receiver according to a first type condition;
where the first state is a sleep state of the first receiver;
where the first type condition includes at least one of: a condition in which a determination is made based on a retention duration; a condition in which a determination is made based on a signal quality; a condition in which a determination is made based on a movement speed of the terminal;
where the first operation includes one of: entering the first state or exiting the first state.

In a third aspect, an embodiment of the present disclosure provides a communication apparatus. The communication apparatus includes:
a memory including executable instructions; and
one or more processors;
wherein when the executable instructions are executed by the processor, the communication apparatus is caused to perform the communication method described in the optional implementations of the first aspect.

In a fourth aspect, an embodiment of the present disclosure provides a storage medium storing instructions. When the instructions run on a communication device, the communication device is caused to perform the communication method described in the optional implementations of the first aspect.

In a fifth aspect, an embodiment of the present disclosure provides a program product. When the program product is executed by a communication device, the communication device is caused to perform the communication method described in the optional implementations of the first aspect.

In a sixth aspect, an embodiment of the present disclosure provides a computer program. When the computer program runs on a computer, the computer is caused to perform the communication method described in the optional implementations of the first aspect.

It can be understood that the aforementioned terminal, apparatus, storage medium, program product, computer program are all used to perform the methods provided in the embodiments of the present disclosure. Therefore, for the beneficial effects that can be achieved, reference can be made to the beneficial effects in the corresponding methods, which will not be repeated here.

The embodiments of the present disclosure provide a communication method, a terminal, an apparatus and a storage medium. In some embodiments, the “communication method” can be used interchangeably with the terms such as “information processing method”, “information transmission method”, etc.

The embodiments of the present disclosure are not exhaustive, but are merely illustrative of some embodiments, and are not intended to be a specific limitation on the protection scope of the present disclosure. In the case of no contradiction, each step in a certain embodiment can be implemented as an independent embodiment, and the steps can be arbitrarily combined. For example, a solution obtained from removing some steps from a certain embodiment can also be implemented as an independent embodiment, and the order of the steps in a certain embodiment can be arbitrarily exchanged. In addition, the optional implementations in a certain embodiment can be arbitrarily combined; in addition, the embodiments can be arbitrarily combined. For example, some or all steps of different embodiments can be arbitrarily combined, and a certain embodiment can be arbitrarily combined with the optional implementations of other embodiments.

In the respective embodiments of the present disclosure, unless otherwise specified or provided for by logic, the terms and/or descriptions between the embodiments are consistent and can be referenced by each other. The technical features in different embodiments can be combined to form a new embodiment based on their inherent logical relationships.

The terms used in the embodiments of the present disclosure are only for the purpose of describing specific embodiments and are not intended to limit the present disclosure.

In the embodiments of the present disclosure, unless otherwise specified, elements expressed in the singular form, such as “a”, “an”, “the”, “above”, “said”, “foregoing”, “this”, etc., may mean “one and only one”, or “one or more”, “at least one”, etc. For example, when articles such as “a”, “an”, or “the”, etc., in English are used in translation, the noun following the article may be understood as a singular expression form or a plural expression form.

In the embodiments of the present disclosure, “a plurality of” refers to two or more.

In some embodiments, the terms such as “at least one of”, “one or more”, “a plurality of”, “multiple”, etc., may be used interchangeably.

In the embodiments of the present disclosure, descriptions such as “at least one of A or B”, “A and/or B”, “in one case, A, and in another case, B”, or “one case, A, and another case, B”, etc., can include the following technical solutions depending on the situation: in some embodiments, A (executing A independently of B); in some embodiments, B (executing B independently of A); in some embodiments, selecting from A and B and executing (A and B being selectively executed); and in some embodiments, A and B (executing both A and B). The same applies when there are more branches, such as A, B, and C, etc.

In some embodiments, descriptions such as “A or B”, etc. may include the following technical solutions depending on the situation: in some embodiments, A (executing A independently of B); in some embodiments, B (executing B independently of A); and in some embodiments, selecting from A and B and executing (A and B being selectively executed). The same applies when there are more branches such as A, B, and C, etc.

The prefixes “first” and “second” in some embodiments of the present disclosure are merely used to distinguish between different description objects and do not constitute any restriction on the position, order, priority, quantity, or content of the description objects. For the statement of the description object, please refer to the description in the context of the claims or embodiments, and no unnecessary restriction should be constituted due to the use of the prefixes. For example, if the description object is a “field”, the ordinal number before the “field” in the “first field” and the “second field” does not limit the position or order between the “fields”. “First” and “second” do not limit whether the “fields” modified by them are in the same message or not, nor do they limit the order of the “first field” and the “second field”. For another example, if the description object is a “level”, the ordinal number before the “level” in the “first level” and the “second level” does not limit the priority between the “levels”. For another example, the number of the description objects is not limited by the ordinal number and can be one or more. Taking “first apparatus” as an example, the number of “apparatuses” can be one or more. In addition, the objects modified by different prefixes can be the same or different. For example, if the description object is “apparatus”, then the “first apparatus” and the “second apparatus” can be the same apparatus or different apparatuses, and their types can be the same or different; for another example, if the description object is “information”, then the “first information” and the “second information” can be the same information or different information, and their contents can be the same or different.

In some embodiments, “including A”, “containing A”, “for indicating A”, and “carrying A” can be interpreted as directly carrying A or indirectly indicating A.

In some embodiments, the terms such as “in response to determining . . . ”, “in response to . . . ”, “determining . . . ”, “in the case of . . . ”, “when . . . ”, “at the time of . . . ”, “if . . . ”, “provided . . . ”, etc., can be used interchangeably.

In some embodiments, the terms such as “greater than”, “greater than or equal to”, “not less than”, “more than”, “more than or equal to”, “not less than”, “higher than”, “higher than or equal to”, “not lower than”, “above”, etc. can be used interchangeably, and terms such as “less than”, “less than or equal to”, “not greater than”, “less than”, “less than or equal to”, “not more than”, “lower than”, “lower than or equal to”, “not higher than”, “below”, etc. can be used interchangeably.

In some embodiments, the apparatus and so on can be interpreted as physical or virtual, and its name is not limited to the name described in the embodiments. Terms such as “apparatus”, “equipment”, “device”, “circuit”, “network element”, “node”, “function”, “unit”, “section”, “system”, “network”, “chip”, “chip system”, “entity”, “subject”, or the like, can be used interchangeably.

In some embodiments, “network” can be interpreted as apparatuses included in the network (such as access network devices, core network devices, etc.)

In some embodiments, terms such as “access network device (AN device)”, “radio access network device (RAN device)”, “base station (BS)”, “radio base station”, “fixed station”, “node”, “access point”, “transmission point (TP)”, “reception point (RP)”, “transmission reception point (transmission/reception point, TRP)”, “panel”, “antenna panel”, “antenna array”, “cell”, “macro cell”, “small cell”, “femto cell”, “pico cell” “sector”, “cell group”, “serving cell”, “carrier”, “component carrier”, “bandwidth part (BWP)”, or the like, can be used interchangeably.

In some embodiments, terms such as “terminal”, “terminal device”, “user equipment (UE)”, “user terminal”, “mobile station (MS)”, “mobile terminal (MT)”, “subscriber station”, “mobile unit”, “subscriber unit”, “wireless unit”, “remote unit”, “mobile device”, “wireless device”, “wireless communication device”, “remote device”, “mobile subscriber station”, “access terminal”, “mobile terminal”, “wireless terminal”, “remote terminal”, “handset”, “user agent”, “mobile client”, “client”, or the like, can be used interchangeably.

In some embodiments, the access network device, the core network device, or the network device may be replaced by a terminal. For example, embodiments of the present disclosure may also be applied to a structure where communications between the access network device, the core network device, or the network device and a terminal is replaced by communications between multiple terminals (e.g., device-to-device (D2D), vehicle-to-everything (V2X), etc.). In this case, a structure in which a terminal has all or part of functions of the access network device may be set. Furthermore, terms such as “uplink”, “downlink”, etc., may be replaced with terms corresponding to communications between terminals (e.g., “side”, “sidelink”). For example, an uplink channel, a downlink channel, etc., may be replaced with a sidelink channel, and an uplink, a downlink, etc., may be replaced with a sidelink.

In some embodiments, the terminal may be replaced by an access network device, a core network device, or a network device. In this case, a structure in which the access network device, the core network device, or the network device may have all or a part of the functions of the terminal may be set.

In some embodiments, obtaining data, information, etc. may comply with the laws and regulations of the country where the obtaining is performed.

In some embodiments, data, information, etc., may be obtained with the user's consent.

Furthermore, each element, each row, or each column in the table of the embodiments of the present disclosure can be implemented as an independent embodiment, and a combination of any element, any row, or any column can also be implemented as an independent embodiment.

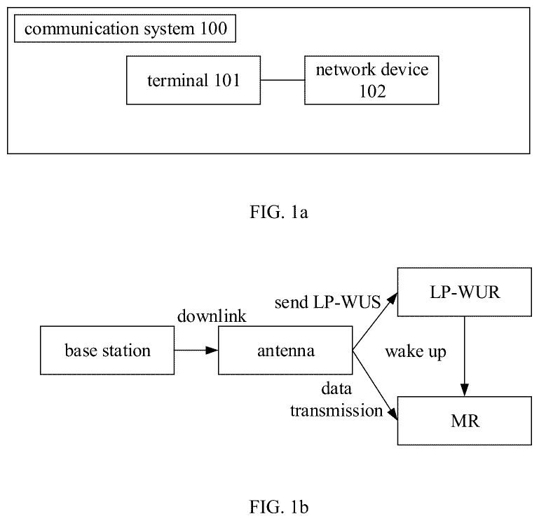

FIG. 1a is a schematic diagram of the architecture of a communication system according to an embodiment of the present disclosure.

As shown in FIG. 1a, the communication system 100 includes a terminal 101 and a network device 102. The network device may be an access network device or a core network device.

In some embodiments, the terminal includes, but is not limited to, at least one of the following: a mobile phone, a wearable device, an Internet of Things device, a car with communication function, a smart car, a tablet computer (Pad), a computer with wireless transceiver function, a virtual reality (VR) terminal device, an augmented reality (AR) terminal device, a wireless terminal device in industrial control, a wireless terminal device in self-driving, a wireless terminal device in remote medical surgery, a wireless terminal device in smart grid, a wireless terminal device in transportation safety, a wireless terminal device in smart city, or a wireless terminal device in smart home.

In some embodiments, the access network device may be, for example, a node or device that enables a terminal to access a wireless network. The access network device may include, but is not limited to, at least one of the following: an evolved Node B (eNB) in a 5G communication system, a next-generation evolved Node B (ng-eNB), a next-generation Node B (gNB), a node B (NB), a home node B (HNB), a home evolved node B (HeNB), a wireless backhaul device, a radio network controller (RNC), a base station controller (BSC), a base transceiver station (BTS), a base band unit (BBU), a mobile switching center, a base station in a 6G communication system, an open base station (open RAN), a cloud base station (cloud RAN), a base station in other communication systems, or an access node in a Wi-Fi system.

In some embodiments, the technical solutions of the present disclosure can be applicable to the Open RAN architecture. In this case, the interfaces between access network devices or interfaces within an access network device involved in the embodiments of the present disclosure can be changed into internal interfaces of the Open RAN, and the processes and information interactions between these internal interfaces can be implemented through software or programs.

In some embodiments, the access network device may be formed of a central unit (CU) and a distributed unit (DU), where the CU may also be referred to as a control unit. The CU-DU structure may be used to separate the protocol layers of the access network device, with some functions of the protocol layers being placed in and centrally controlled by the CU and some or all of the remaining functions of the protocol layers being distributed in the DU and centrally controlled by the CU, but it is not limited thereto.

In some embodiments, the core network device may be a device, including a first network element, etc., or the core network device may be a plurality of devices or a device cluster, including the first network element. The network element(s) can be virtual or physical. For example, the core network includes at least one of: an Evolved Packet Core (EPC), a 5G Core Network (5GCN), or a Next Generation Core (NGC).

It is understood that the communication system described in the embodiments of the present disclosure is for the purpose of more clearly illustrating the technical solutions of the present disclosure, and does not constitute a limitation on the technical solutions provided in the present disclosure. As those skilled in the art will know, with the evolution of system architecture and the emergence of new business scenarios, the technical solutions provided in the embodiments of the present disclosure are also applicable to similar technical problems.

The following embodiments of the present disclosure can be applied to the communication system 100 shown in FIG. 1a, or to some of the subjects, but are not limited thereto. The subjects shown in FIG. 1a are illustrative. The communication system may include all or some of the subjects in FIG. 1a, or it may include subjects other than those of FIG. 1a. The number and configuration of the subjects are arbitrary, and the connection relationship between the subjects is illustrative. The subjects may not be connected or may be connected, and the connection can be in any way, which may be a direct connection or an indirect connection, a wired connection or a wireless connection.

Embodiments of the present disclosure may be applied to Long Term Evolution (LTE), LTE-Advanced (LTE-A), LTE-Beyond (LTE-B), SUPER 3G, IMT-Advanced, 4th generation mobile communication system (4G), 5th generation mobile communication system (5G), 5G new radio (NR), Future Radio Access (FRA), New-Radio Access Technology (RAT), New Radio (NR), New radio access (NX), Future generation radio access (FX), Global System for Mobile communications (GSM (registered trademark)), CDMA2000, Ultra Mobile Broadband (UMB), IEEE 802.11 (Wi-Fi (registered trademark)), IEEE 802.16 (WiMAX (registered trademark)), IEEE 802.20, Ultra-Wideband (UWB), Bluetooth (a registered trademark), Public Land Mobile Network (PLMN) networks, Device-to-Device (D2D) systems, Machine-to-Machine (M2M) systems, Internet of Things (IoT) systems, Vehicle-to-Everything (V2X) systems, systems utilizing other communication methods, next-generation systems built upon them, or the like. Furthermore, a combination of multiple systems (e.g., a combination of LTE or LTE-A with 5G) can be applied.

In some embodiments, the 5th generation mobile communication technology (5G) has been introduced due to the pursuit of speed, latency, high-speed mobility, energy efficiency, and the increasing diversity and complexity of services in future life. The main application scenarios of 5G are as follows: enhanced mobile broadband (eMBB), ultra-reliable and low latency communications (URLLC), massive machine type communication (mMTC). Among these, eMBB still aims to provide users with multimedia content, services, and data, and its demand is growing rapidly. On the other hand, because eMBB may be deployed in different scenarios, such as indoors, urban areas, rural areas, etc., its capabilities and requirements vary considerably, and therefore it cannot be generalized; a detailed analysis based on the specific deployment scenario is necessary. Typical applications of URLLC include: industrial automation, power automation, remote medical operations (surgery), traffic safety assurance, etc. Typical characteristics of mMTC include: high connection density, small data volume, latency-insensitive services, low module cost, and long module lifespan, etc.

In some embodiments, 5G terminals consume a lot of power. In order to save power for terminals, many terminal power-saving technologies have been introduced, for example, Connected Discontinuous Reception (C-DRX) and measurement relaxation, etc., which are supported by both 4G and 5G.

In some embodiments, a Wake Up Signal (WUS) is introduced to save power for a terminal in a radio resource control connected state (RRC_CONNECTED). An offset preceding an on duration of the UE C-DRX defines a period of time (duration) for sending the WUS signal. During the WUS duration, the WUS signal is sent, i.e., Downlink Control Information (DCI) 2-6, scrambled by Power Saving RNTI (PS-RNTI) for indicating whether the terminal wakes up in the next C-DRX on duration of the terminal to monitor a Physical Downlink Control Channel (PDCCH).

In some embodiments, a paging WUS is introduced to save power for a terminal in a radio resource control idle state (RRC_IDLE) or a radio resource control inactive state (RRC_INACTIVE). That is, sending of the paging WUS (i.e., paging early indication (PEI)) is started at a certain time before a Paging Occasion (PO), to indicate whether the terminal monitors paging scheduling information at the PO. The PEI is DCI 2-7, scrambled by PEI-RNTI (Paging Early Indication-Radio Network Temporary Identifier).

In some embodiments, as shown in FIG. 1b, an LP-WUR is introduced to further implement terminal power saving. A base station sends a low power wake up signal to a terminal to wake up the terminal with a main receiver in sleep. At this time, the main receiver of the terminal is asleep, and the LP-WUR is used to receive the LP WUS. After the LP WUS is received, the main receiver of the terminal may be woken up to perform operations such as data transmission and reception, etc. The power consumption of the lower power receiver of the terminal is significantly lower than that of the main receiver of the terminal

In the embodiments of the present disclosure, a terminal may include a main receiver (Main Radio, MR) and an LP-WUR (or a Low Power Receiver, LR). It should be noted that the MR may also be referred to as a first receiver and a first transceiver in some scenarios, and the LP-WUR may also be referred to as a second receiver and a second transceiver in some scenarios, and the present disclosure does not impose limitations on this.

In some embodiments, the power of the LP-WUR is less than the power of the MR.

In some embodiments, the MR can be used for transmission and reception of New Radio (NR) signal(s) or channel(s) other than transmission and reception of signal(s) or channel(s) associated with low power wake up.

In some embodiments, the LR can be used for transmission and reception of signal(s) or channel(s) associated with low power wake up, or processing of signal(s) or channel(s) associated with low power wake up.

In some embodiments, a terminal determines whether the MR enters or leaves (exits) a sleep state (corresponding to a first state in the present disclosure), such as ultra-deep sleep, based on signal measurement.

In some embodiments, entry into the ultra-deep sleep may be based on a signal (e.g., a synchronization signal block (SSB, Synchronization Signal/PBCH Block) in the MR or a signal (e.g., a measurement result of the LP-SS) in the LR. Exit from the ultra-deep sleep may be based on a measurement result of the signal in the LR, such as the LP-SS. This results in ping-pong switching between entering the ultra-deep sleep or exiting the ultra-deep sleep, for example, when condition(s) for entering/exiting the ultra-deep sleep are not well configured, especially when the signal controlling ultra-deep sleep entry and the signal controlling ultra-deep sleep exit is different.

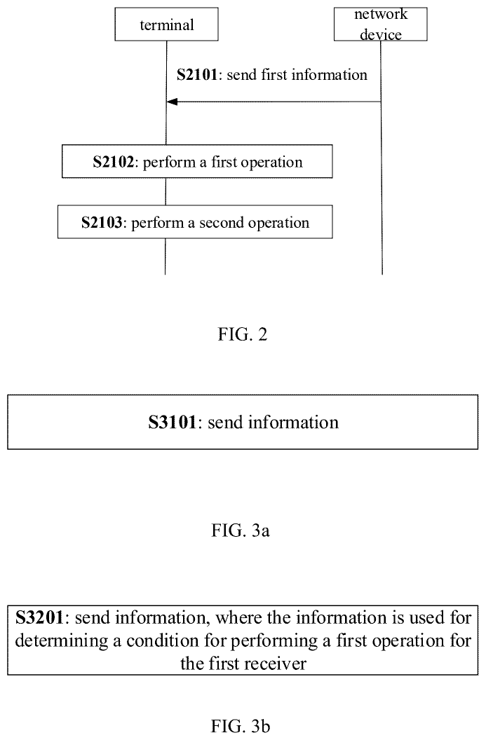

FIG. 2 is a schematic diagram showing interactions of a communication method according to an embodiment of the present disclosure. As shown in FIG. 2, the embodiment of the present disclosure relates to a communication method applied in the communication system 100. The method includes:

In step S2101, a network device sends information to a terminal.

In some embodiments, the terminal receives the information sent by the network device.

In some embodiments, the information is used for determining a condition for performing a first operation for a first receiver.

In some embodiments, step S2101 may be an optional step, that is, when the terminal is configured with the information, step S2101 may be omitted.

In some embodiments, the information is first information.

In some embodiments, the first information indicates at least one of: a first duration, a first signal quality threshold, a first hysteresis, a second duration, a second signal quality threshold, a second hysteresis, and a first period.

In some embodiments, the information is second information.

In some embodiments, the second information indicates at least one of: a third duration, a third signal quality threshold, a third hysteresis, a fourth signal quality threshold, a fourth hysteresis, a fourth duration, a fifth signal quality threshold, a fifth hysteresis, a sixth signal quality threshold, and a sixth hysteresis.

In some embodiments, the information is third information.

In some embodiments, the third information indicates at least one of: a fifth duration, a first speed threshold, a first offset value, a second speed threshold, a second offset value, a sixth duration, a third speed threshold, a third offset value, a fourth speed threshold, and a fourth offset value.

In some embodiments, the information is fourth information.

In some embodiments, the fourth information indicates that a reference signal is a first signal or a second signal.

In some embodiments, the reference signal is one of:
a first signal that is a signal received by the first receiver;
a second signal that is a signal received by a second receiver.

In some embodiments, the first signal is a synchronization signal block SSB; the second signal is a low power synchronization signal LP-SS.

In some embodiments, the reference signal is a reference signal used to determine a quality of a wireless transmission.

In some embodiments, the information is the fifth information.

In some embodiments, the fifth information includes at least one of: LP-SS configuration information; LP-WUS configuration information.

In some embodiments, the terminal may receive the fifth information in an RRC idle state or an RRC inactive state.

In some embodiments, a system message sent by a network device is received, and the system message includes the fifth information.

In some embodiments, the fifth information includes at least one of:
information about a Frequency Range FR (e.g., a first frequency range (FR1, Frequency range1) or a second frequency range);
duty cycle information for monitoring the LP-WUS;
a time-domain resource (e.g., a slot index within a period) and/or a frequency-domain resource (e.g., 20 sub-channels in a 5 MHz frequency resource) for monitoring the LP-WUS.
a scramble code for addressing the terminal (e.g., a scramble code in a sub-channel and/or a slot).
a validity area or a timer for the LP-WUS configuration;
a specific Radio Network Temporary Identity (RNTI) for LP-WUS activation or deactivation;
a waveform for the LP-WUS;
configuration information for beam sweeping for LP-WUS transmission;
a frequency offset between the main receiver (MR) and the low power receiver (LR) of the terminal and/or a downlink (DL) timing offset between the MR and the LR.

In step S2102, the terminal performs the first operation.

In some embodiments, the terminal performs the first operation for the first receiver according to a first type condition.

In some embodiments, the first state is a sleep state of the first receiver, for example, an ultra-deep sleep state.

In some embodiments, the first type condition includes at least one of: a condition in which a determination is made based on a retention duration; a condition in which a determination is made based on a signal quality; a condition in which a determination is made based on a movement speed of the terminal.

In some embodiments, the retention duration may be a duration of maintaining in the first state, or a duration of maintaining out of the first state after exiting the first state.

In some embodiments, the first type condition includes at least one of: a condition in which a determination is made based on a retention duration; a condition in which a determination is made based on a signal quality (a signal quality of a reference signal); a condition in which a determination is made based on a movement speed of the terminal. In some embodiments, the first type condition includes at least one of: a condition in which a determination is made based on the retention duration; a condition in which a determination is made based on a signal quality threshold used within a specified period of time; a condition in which a determination is made based on a terminal movement speed threshold used within a specified period of time.

In some embodiments, the first operation includes one of: entering the first state or exiting the first state.

In some embodiments, after the first receiver of the terminal enters or exits the first state, the terminal performs the first operation for the first receiver according to the first type condition.

In some embodiments, the terminal determines whether the first receiver enters or exits the first state based on a second type condition.

In some embodiments, the second type condition includes at least one of:
a condition in which a determination is made based on a signal quality;
a condition in which a determination is made on the movement speed of the terminal.

In some embodiments, the second type condition includes at least one of:
a condition in which a determination is made based on a signal quality threshold;
a condition in which a determination is made based on the movement speed threshold of the terminal.

As an example:
the second type condition for the first receiver to enter the first state may be: Ms−Hys>Thresh1 or Ms>Thresh1;
the second type condition for the first receiver to exit (or leave) the first state may be: Ms+Hys<Thresh1 or Ms<Thresh1;
where Ms may be a signal quality measurement quantity, Hys may be a hysteresis deviation, and Thresh1 may be a signal quality threshold.

As an example:
the second type condition for the first receiver to exit (or leave) the first state may be: V1−V2>Thresh2 or V1>Thresh2;
the second type condition for the first receiver to enter the first state may be: V1+V2<Thresh2 or V1<Thresh2;
where V1 may be the movement speed of the terminal, V2 may be an offset value, and Thresh2 may be a movement speed threshold of the terminal.

In some embodiments, the first receiver can exit the first state after maintaining in the first state for at least a first duration after the first receiver enters the first state.

In some embodiments, after the first receiver enters the first state, the first receiver maintains in the first state for at least the first duration, and it is determined that a signal quality of a reference signal received by the terminal is less than or equal to a first signal quality threshold, the first receiver exits the first state.

In some embodiments, after the first receiver enters the first state, the first receiver maintains the first state for at least the first duration, and it is determined that a sum of the signal quality of the reference signal received by the terminal and a first hysteresis is less than or equal to the first signal quality threshold, the first receiver exits the first state.

In some embodiments, the first receiver can enter the first state after maintaining out of the first state for at least a second duration after the first receiver exists the first state.

In some embodiments, after the first receiver exits the first state, the first receiver maintains out of the first state for at least the second duration, and it is determined that the signal quality of the reference signal received by the terminal is greater than or equal to a second signal quality threshold, the first receiver enters the first state.

In some embodiments, after the first receiver exits the first state, the first receiver maintains out of the first state for at least the second duration, and it is determined that a difference between the signal quality of the reference signal received by the terminal and a second hysteresis is greater than or equal to the second signal quality threshold, the first receiver enters the first state.

In some embodiments, at least one of the following is determined based on a predetermined communication rule: the first duration, the first signal quality threshold, the first hysteresis, the second duration, the second signal quality threshold, the second hysteresis, and the first period.

In some embodiments, based on the received first information, at least one of the following is determined: the first duration, the first signal quality threshold, the first hysteresis, the second duration, the second signal quality threshold, the second hysteresis, and the first period.

In some embodiments, after the first receiver enters the first state, within a third duration, it is determined that the signal quality of the reference signal received by the terminal is less than or equal to a third signal quality threshold, the first receiver exits the first state.

In some embodiments, after the first receiver enters the first state, within the third duration, it is determined that a sum of the signal quality of the reference signal received by the terminal and a third hysteresis is less than or equal to the third signal quality threshold, the first receiver exits the first state.

In some embodiments, after the first receiver enters the first state, the first receiver maintains the state unchanged after the third duration; it is determined that the signal quality of the reference signal received by the terminal is less than or equal to a fourth signal quality threshold, the first receiver exits the first state.

In some embodiments, after the first receiver enters the first state, the first receiver maintains the state unchanged after the third duration; it is determined that a sum of the signal quality of the reference signal received by the terminal and a fourth hysteresis is less than or equal to the fourth signal quality threshold, the first receiver exits the first state.

In some embodiments, the third signal quality threshold and the fourth signal quality threshold are different.

In some embodiments, values of the third hysteresis and the fourth hysteresis are different.

In some embodiments, after the first receiver exits the first state, within a fourth duration, it is determined that the signal quality of the reference signal received by the terminal is greater than or equal to a fifth signal quality threshold, the first receiver enters the first state.

In some embodiments, after the first receiver exits the first state, within the fourth duration, it is determined that a difference between the signal quality of the reference signal received by the terminal and a fifth hysteresis is greater than or equal to the fifth signal quality threshold, the first receiver enters the first state.

In some embodiments, after the first receiver exits the first state, the first receiver maintains the state unchanged after the fourth duration; it is determined that the signal quality of the reference signal received by the terminal is greater than or equal to a sixth signal quality threshold, the first receiver enters the first state.

In some embodiments, after the first receiver exits the first state, the first receiver maintains the state unchanged after the fourth duration; it is determined that the difference between the signal quality of the reference signal received by the terminal and the sixth hysteresis is greater than or equal to the sixth signal quality threshold, the first receiver enters the first state.

In some embodiments, the fifth signal quality threshold and the sixth signal threshold are different.

In some embodiments, values of the fifth hysteresis and the sixth hysteresis are different.

In some embodiments, at least one of the following is determined based on a predetermined communication rule: the third duration, the third signal quality threshold, the third hysteresis, the fourth signal quality threshold, the fourth hysteresis, the fourth duration, the fifth signal quality threshold, the fifth hysteresis, the sixth signal quality threshold, and the sixth hysteresis.

In some embodiments, based on the received second information, at least one of the following is determined: the third duration, the third signal quality threshold, the third hysteresis, the fourth signal quality threshold, the fourth hysteresis, the fourth duration, the fifth signal quality threshold, the fifth hysteresis, the sixth signal quality threshold, and the sixth hysteresis.

In some embodiments, after the first receiver enters the first state, within a fifth duration, it is determined that the movement speed of the terminal is greater than or equal to a first speed threshold, the first receiver exits the first state.

In some embodiments, after the first receiver enters the first state, within the fifth duration, it is determined that a difference between the movement speed of the terminal and a first offset value is greater than or equal to the first speed threshold, the first receiver exits the first state.

In some embodiments, after the first receiver enters the first state, the first receiver maintains the state unchanged after the fifth duration; it is determined that the movement speed of the terminal is greater than or equal to a second speed threshold, the first receiver exits the first state.

In some embodiments, after the first receiver enters the first state, the first receiver maintains the state unchanged after the fifth duration; it is determined that a difference between the movement speed of the terminal and a second offset value is greater than or equal to the second speed threshold, the first receiver exits the first state.

In some embodiments, the first speed threshold and the second speed threshold are different.

In some embodiments, the first offset value and the second offset value are different.

In some embodiments, after the first receiver exits the first state, within a sixth duration, it is determined that the movement speed of the terminal is less than or equal to a third speed threshold, the first receiver enters the first state.

In some embodiments, after the first receiver exits the first state, within the sixth duration, it is determined that a sum of the movement speed of the terminal and the third offset value is less than or equal to the third speed threshold, the first receiver enters the first state.

In some embodiments, after the first receiver exits the first state, the first receiver maintains the state unchanged after the sixth duration; it is determined that the movement speed of the terminal is less than or equal to a fourth speed threshold, the first receiver enters the first state.

In some embodiments, after the first receiver exits the first state, the first receiver maintains the state unchanged after the sixth duration; it is determined that a sum of the movement speed of the terminal and a fourth offset value is less than or equal to the fourth speed threshold, the first receiver enters the first state.

In some embodiments, the third speed threshold and the fourth speed threshold are different.

In some embodiments, the third offset value and the fourth offset value are different.

In some embodiments, at least one of the following is determined based on a predetermined communication rule: the fifth duration, the first speed threshold, the first offset value, the second speed threshold, the second offset value, the sixth duration, the third speed threshold, the third offset value, the fourth speed threshold, and the fourth offset value.

In some embodiments, based on the received third information, at least one of the following is determined: the fifth duration, the first speed threshold, the first offset value, the second speed threshold, the second offset value, the sixth duration, the third speed threshold, the third offset value, the fourth speed threshold, and the fourth offset value.

In some embodiments, if the number of times of entering and exiting the first state within the first period is greater than or equal to a first quantity, a predetermined duration is increased.

In some embodiments, the predetermined duration includes at least one of: the first duration, the second duration, the third duration, the fourth duration, the fifth duration, and the sixth duration.

In step S2103, the terminal performs a second operation.

In some embodiments, the first receiver is not in the first state, the second operation is performed.

In some embodiments, the first receiver is in the first state, performing of the second operation is stopped, or an active device is turned off.

In some embodiments, the second operation includes at least one of:
monitoring a downlink (DL) channel;
receiving a downlink (DL) channel;
sending an uplink (UL) signal;
sending uplink (UL) data.

In some embodiments, the term “information” may be used interchangeably with terms such as “message”, “signal”, “signaling”, “report”, “configuration”, “indication”, “instruction”, “command”, “channel”, “parameter”, “field”, “data”, etc.

In some embodiments, the term “send” may be used interchangeably with terms such as “transmit”, “report”, or “deliver”, etc.

The communication method involved in the embodiments of the present disclosure may include at least one of steps S2101 to S2103. For example, step S2101 may be implemented as an independent embodiment, step S2102 may be implemented as an independent embodiment, and step S2103 may be implemented as an independent embodiment. For example, a combination of step S2101 and step S2102 may be implemented as an independent embodiment, and a combination of step S2102 and step S2103 may be implemented as an independent, and the present disclosure does not impose limitations on this.

FIG. 3a is a schematic flowchart of a communication method according to an embodiment of the present disclosure. As shown in FIG. 3a, the embodiment of the present disclosure relates to a communication method performed by a network device. The method includes:

In step S3101, information is sent.

In some embodiments, regarding the optional implementations of step S3101, reference may be made to the optional implementations of step S2101 in FIG. 2 and other related parts in the embodiments involved in FIG. 2, and repeated descriptions will be omitted here.

FIG. 3b is a schematic flowchart of a communication method according to an embodiment of the present disclosure. As shown in FIG. 3b, the embodiment of the present disclosure relates to a communication method performed by a network device. The method includes:

In step S3201, information is sent. The information is used to determine a condition for performing a first operation for a first receiver.

In some embodiments, regarding the optional implementations of step S3201, reference may be made to the optional implementations of step S2101 in FIG. 2 and other related parts in the embodiments involved in FIG. 2, and repeated descriptions will be omitted here.

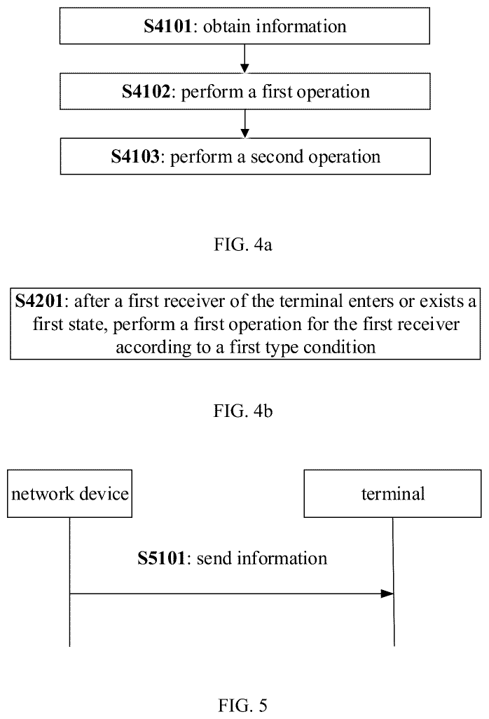

FIG. 4a is a schematic flowchart of a communication method according to an embodiment of the present disclosure. As shown in FIG. 4a, the embodiment of the present disclosure relates to a communication method performed by a terminal. The method includes:

In step S4101, information is obtained.

In some embodiments, the terminal obtains the information sent by a network device. But, the present disclosure is not limited to this, and the terminal may receive first information sent by other entity.

In some embodiments, the terminal obtains the information defined by a protocol.

In some embodiments, the terminal obtains the information from upper layer(s).

In some embodiments, the terminal obtains the information through processing.

In some embodiments, step S4101 is omitted, and the terminal autonomously implements the function indicated by the information, or the function is default or as a default.

In some embodiments, regarding the optional implementations of step S4101, reference may be made to the optional implementations of step S2101 in FIG. 2 and other related parts in the embodiments involved in FIG. 2, and repeated descriptions will be omitted here.

In step S4102, the first operation is performed.

In some embodiments, regarding the optional implementations of step S4102, reference may be made to the optional implementations of step S2102 in FIG. 2 and other related parts in the embodiments involved in FIG. 2, and repeated descriptions will be omitted here.

In step S4103, a second operation is performed.

In some embodiments, regarding the optional implementations of step S4103, reference may be made to the optional implementations of step S2103 in FIG. 2 and other related parts in the embodiments involved in FIG. 2, and repeated descriptions will be omitted here.

The information indication method involved in the embodiments of the present disclosure may include at least one of steps S4101 to S4103. For example, step S4101 may be implemented as an independent embodiment, step S4102 may be implemented as an independent embodiment, and step S4103 may be implemented as an independent embodiment. For example, a combination of step S4101 and step S4102 may be implemented as an independent embodiment, and a combination of step S4102 and step S4103 may be implemented as an independent embodiment, and the present disclosure does not impose limitations on this.

FIG. 4b is a schematic flowchart of a communication method according to an embodiment of the present disclosure. As shown in FIG. 4b, the embodiment of the present disclosure relates to a communication method performed by a terminal. The method includes:

In step S4201, after a first receiver of the terminal enters or exits a first state, a first operation is performed for the first receiver according to a first type condition.

In some embodiments, the first state is a sleep state of the first receiver;
the first type condition includes at least one of: a condition in which a determination is made based on a retention duration; a condition in which a determination is made based on a signal quality threshold used within a specified period of time; or a condition in which a determination is made based on a terminal movement speed threshold used within a specified period of time.

The first operation includes one of: entering the first state or exiting the first state.

In some embodiments, before performing the first operation for the first receiver according to the first type condition, the method further includes:
determining whether the first receiver enters or exits the first state based on a second type condition;
where the second type condition includes at least one of:
a condition in which a determination is made based on a signal quality;
a condition in which a determination is made based on a movement speed of the terminal.

In some embodiments:
performing the first operation for the first receiver according to the first type condition includes: enabling the first receiver to exit the first state after the first receiver maintains the first state for at least a first duration after entering the first state; or
performing the first operation performed for the first receiver according to the first type condition includes: enabling the first receiver to enter the first state after the first receiver maintains out of the first state for at least a second duration after exiting the first state.

In some embodiments, enabling the first receiver to exit the first state after the first receiver maintains for at least the first duration after entering the first state includes:
after the first receiver enters the first state, maintaining the first state for at least the first duration, and determining that a signal quality of a reference signal received by the terminal is less than or equal to a first signal quality threshold, exiting the first state; or
after the first receiver enters the first state, maintaining the first state for at least the first duration, and determining that a sum of the signal quality of the reference signal received by the terminal and a first hysteresis is less than or equal to the first signal quality threshold, exiting the first state.

In some embodiments, enabling the first receiver to enter the first state after the first receiver maintains out of the first state for at least the second duration after exiting the first state includes:
after the first receiver exits the first state, maintaining out of the first state for at least the second duration, and determining that a signal quality of a reference signal received by the terminal is greater than or equal to a second signal quality threshold, entering the first state; or
after the first receiver exits the first state, maintaining out of the first state for at least the second duration, and determining that a difference between the signal quality of the reference signal received by the terminal and a second hysteresis is greater than or equal to the second signal quality threshold, entering the first state.

In some embodiments, the method further includes:
based on a predetermined communication rule and/or received first information, determining at least one of: the first duration, the first signal quality threshold, the first hysteresis, the second duration, the second signal quality threshold, the second hysteresis, and the first period.

In some embodiments, performing the first operation for the first receiver according to the first type condition includes:
after the first receiver enters the first state, within a third duration, determining that a signal quality of a reference signal received by the terminal is less than or equal to a third signal quality threshold, exiting the first state; or
after the first receiver enters the first state, within the third duration, determining that a sum of the signal quality of the reference signal received by the terminal and a third hysteresis is less than or equal to the third signal quality threshold, exiting the first state.

In some embodiments, performing the first operation for the first receiver according to the first type condition includes:
after the first receiver enters the first state, maintaining the state unchanged after the third duration; determining that the signal quality of the reference signal received by the terminal is less than or equal to a fourth signal quality threshold, exiting the first state; or
after the first receiver enters the first state, maintaining the state unchanged after the third duration; determining that a sum of the signal quality of the reference signal received by the terminal and a fourth hysteresis is less than or equal to the fourth signal quality threshold, exiting the first state.

In some embodiments, the third signal quality threshold and the fourth signal quality threshold are different; and/or, values of the third hysteresis and the fourth hysteresis are different.

In some embodiments, performing the first operation for the first receiver according to the first type condition includes:
after the first receiver exits the first state, within a fourth duration, determining that a signal quality of a reference signal received by the terminal is greater than or equal to a fifth signal quality threshold, entering the first state; or
after the first receiver exits the first state, within the fourth duration, determining that a difference between the signal quality of the reference signal received by the terminal and a fifth hysteresis is greater than or equal to a fifth signal quality threshold, entering the first state.

In some embodiments, performing the first operation for the first receiver based on the first type condition includes:
after the first receiver exits the first state, maintaining the state unchanged after the fourth duration; determining that the signal quality of the reference signal received by the terminal is greater than or equal to a sixth signal quality threshold, entering the first state; or
after the first receiver exits the first state, maintaining the state unchanged after the fourth duration; determining that a difference between the signal quality of the reference signal received by the terminal and a sixth hysteresis is greater than or equal to the sixth signal quality threshold, entering the first state.

In some embodiments, the fifth signal quality threshold and the sixth signal threshold are different; and/or, values of the fifth hysteresis and the sixth hysteresis are different.

In some embodiments, the method further includes:
based on a predetermined communication rule and/or received second information, determining at least one of: the third duration, the third signal quality threshold, the third hysteresis, the fourth signal quality threshold, the fourth hysteresis, the fourth duration, the fifth signal quality threshold, the fifth hysteresis, the sixth signal quality threshold, and the sixth hysteresis.

In some embodiments, performing the first operation for the first receiver based on the first type condition includes:
after the first receiver enters the first state, within a fifth duration, determining that the movement speed of the terminal is greater than or equal to a first speed threshold, exiting the first state; or
after the first receiver enters the first state, within the fifth duration, determining that a difference between the movement speed of the terminal and a first offset value is greater than or equal to the first speed threshold, exiting the first state.

In some embodiments, performing the first operation for the first receiver based on the first type condition includes:
after the first receiver enters the first state, maintaining the state unchanged after the fifth duration; determining that the movement speed of the terminal is greater than or equal to a second speed threshold, exiting the first state; or
after the first receiver enters the first state, maintaining the state unchanged after the fifth duration; determining that a difference between the movement speed of the terminal and a second offset value is greater than or equal to a second speed threshold, exiting the first state.

In some embodiments, the first speed threshold and the second threshold are different; and/or, the first offset value and the second offset value are different.

In some embodiments, performing the first operation for the first receiver based on the first type condition includes:
after the first receiver exits the first state, within a sixth duration, determining that the movement speed of the terminal is less than or equal to a third speed threshold, entering the first state; or
after the first receiver exits the first state, within the sixth duration, determining that a sum of the movement speed of the terminal and a third offset value is less than or equal to a third speed threshold, entering the first state.

In some embodiments, performing the first operation for the first receiver based on the first type condition includes:
after the first receiver exits the first state, maintaining the state unchanged after the sixth duration; determining that the movement speed of the terminal is less than or equal to a fourth speed threshold, entering the first state; or
after the first receiver exits the first state, maintaining the state unchanged after the sixth duration; determining that a sum of the movement speed of the terminal and a fourth offset value is less than or equal to a fourth speed threshold, entering the first state.

In some embodiments, the third speed threshold and the fourth speed threshold are different; and/or, the third offset value and the fourth offset value are different.

In some embodiments, the method further includes:
based on a predetermined communication rule and/or received third information, determining at least one of the following: the fifth duration, the first speed threshold, the first offset value, the second speed threshold, the second offset value, the sixth duration, the third speed threshold, the third offset value, the fourth speed threshold, and the fourth offset value.

In some embodiments, the method further includes one of:
if the number of times of entering and exiting the first state within a first period is greater than or equal to a first quantity, increasing a predetermined duration;
where the predetermined duration includes at least one of: the first duration, the second duration, the third duration, the fourth duration, the fifth duration, and the sixth duration.

In some embodiments, the method further includes:
the first receiver being not in the first state, performing a second operation;
or, the first receiver being in the first state, stopping performing the second operation or turning off an active device;
where the second operation includes at least one of the following:
monitoring a downlink (DL) channel;
receiving the downlink (DL) channel;
sending an uplink (UL) signal;
sending uplink (UL) data.

In some embodiments, the reference signal is one of the following:
a first signal that is a signal received by the first receiver;
a second signal that is a signal received by the second receiver.

In some embodiments, the method further includes:
receiving fourth information sent by the network device;
where the fourth information indicates that the reference signal is the first signal or the second signal.

In some embodiments, the first signal is a synchronization signal block SSB; the second signal is a low power synchronization signal LP-SS.

In some embodiments, the method further includes:
receiving fifth message sent by the network device;
where the fifth information includes at least one of: LP-SS configuration information; LP-WUS configuration information.

In some embodiments, receiving the fifth information sent by the network device includes:
receiving a system message sent by the network device, where the system message includes the fifth information.

In some embodiments, the fifth information includes at least one:
information about a Frequency Range (FR);
duty cycle information for monitoring the LP-WUS;
a time-domain resource and/or a frequency-domain resource for monitoring the LP-WUS;
a scramble code for addressing the terminal;
a validity area or a timer for the LP-WUS configuration;
a specific Radio Network Temporary Identifier (RNTI) for LP-WUS activation or deactivation;
a waveform for the LP-WUS;
configuration information for beam sweeping for LP-WUS transmission;
a frequency offset between the first and second receivers of the terminal;
a downlink (DL) timing offset between the first receiver and the second receiver.

FIG. 5 is a schematic diagram showing interactions of a communication method according to an embodiment of the present disclosure. As shown in FIG. 5, the embodiment of the present disclosure relates to a communication method applied in the communication system 100. The method includes one of the following step(s):

In step S5101, a network device sends information to a terminal.

In some embodiments, the information is used to determine a condition for performing a first operation for a first receiver.

Regarding the optional implementations of step S5101, reference may be made to the optional implementation of steps S2101 to S2103 in FIG. 2, and other related parts in the embodiments involved in FIG. 2, and repeated descriptions will be omitted here.

In some embodiments, the method may include the methods in the above-described embodiments at the communication system side, terminal side, network device side, etc., which will not be described in detail here.

The embodiments of the present disclosure relate to a communication method. The method includes:

In some embodiments, after switching (corresponding to entering or exiting the first state in the present disclosure), a certain state is forcibly maintained for a period of time.

In some embodiments, since a channel condition meets a condition (corresponding to the second type condition) for the MR (corresponding to the first receiver in the present disclosure) to enter or exit ultra-deep sleep (corresponding to the first state), once the MR enters or exits the ultra-deep sleep, regardless of whether an entry or exit condition is met, the UE should remain in the target state (the current state) for at least x seconds (maintain the state for a period of time). The value of x may be configured by a network, or may be specified in a specification.

In some embodiments, if the switching is frequent, for example, switching n times within a specified period T, x may be increased by an offset. This offset (corresponding to the offset value) may be configured by the network or may be specified in the specification. The period T may be configured by the network, or may be specified in the specification.

In some embodiments, for the two cases of entering the ultra-deep sleep and leaving the ultra-deep sleep, the parameters configured above may be different or the same (the two cases may share a set of parameters).

In some embodiments, after switching, different switching condition(s) or parameter(s) is (are) used for a period of time to determine whether to switch.

In some embodiments, since a channel condition meets a condition for the MR to enter or exit the ultra-deep sleep, after occurrence of entering or exiting the ultra-deep sleep, the UE uses a set of signal quality threshold, velocity threshold, hysteresis, and/or offset to evaluate whether to exit the current state. After a specified period of time, the UE uses another set of signal quality threshold, velocity threshold, hysteresis, and/or offset to evaluate whether to exit the current state. The two sets of configurations are configured through system broadcasting. The configuration includes at least one of the following: threshold, hysteresis, offset.

For example, based on a timer configured by the network side, when entering/exiting the ultra-deep sleep occurs, the timer is started. Before the timer expires, a parameter or condition 1 is used to determine whether to exit the current state. After the timer expires, a parameter or condition 2 is used to determine whether to exit the current state.

In some embodiments, for the two cases of entering the ultra-deep sleep and leaving the ultra-deep sleep, the parameters configured above may be different or the same (the two cases share a set of parameters).

In some embodiments, the expression that “since the channel condition meets a condition for the MR to enter or exit the ultra-deep sleep” may be further refined as follows:
a condition for the MR to enter the ultra-deep sleep: Ms−Hys>Thresh or Ms>Thresh;
a condition for the MR to leave the ultra-deep sleep: Ms+Hys<Thresh or Ms<Thresh;
where Ms is a signal measurement quantity under a target state, Hys is a hysteresis deviation, Thresh is a threshold, and Hys and Thresh are configured by the network side.

In some embodiments, entry into the ultra-deep sleep may be based on a signal (e.g., SSB) in the MR or a signal (e.g., a measurement result of LP-SS) in the LR. Exit from the ultra-deep sleep may be based on a measurement result of a signal in the LR, such as LP-SS. Alternatively, the choice of which signal to use depends on a network-side configuration.

In some embodiments, the “ultra-deep sleep” may be:

Option a: exiting “ultra-deep sleep” is performed, the MR side of the terminal is activated to start to monitor or receive a DL channel and/or send uplink signal(s) or data. Entering “ultra-deep sleep” is performed, the MR side of the terminal is deactivated, monitoring/receiving the DL channel is not performed, and sending uplink signal(s) or data is not performed.

Option b: exiting “ultra-deep sleep” is performed, the MR side of the terminal is activated to start to monitor or receive the DL channel, and/or send uplink signal(s) or data. Entering “ultra-deep sleep” is performed, the MR side of the terminal is deactivated, and an active device is turned off, etc.

In some embodiments, the “ultra-deep sleep state” has the following definition and conclusion:

| | Relative | Ramp-up and down | | |
|---|---|---|---|---|
| | power | transition energy | | Time for |
| Power | consumption | (unit multiplied by | Ramp-up | sync/re- |
| state | (unit) | milliseconds) | time | sync |
| ultra- | [0.015] | [2000~40000] | [400 ms] | X |
| deep | | Further study to | For further | |
| sleep | | converge on | study: 100 | |
| | | candidate numbers | ms | |
| | | to use for | | |
| | | evaluation | | |
| | | For further study: | | |
| | | other values and | | |
| | | reports | | |
| | | For further study: | | |
| | | down-selection of | | |
| | | values | | |
| | | Companies are | | |
| | | encouraged to | | |
| | | provide details for | | |
| | | down-selection | | |

The following agreement was reached:

For evaluation, at least for FR1 MR ultra-deep sleep state, (ramp-up or down transition energy, ramp-up time) is as follows:
Alternative 1: (15000, 400 ms) as baseline;
Alternative 2: ([40000], [800 ms]);

It should be noted that companies report which alternatives they use for which use cases.

In some embodiments, ping-pong prevention is achieved by triggering the MR to enter or exit the ultra-deep sleep state based on the movement speed of the UE.

In some embodiments, the terminal determines that the MR enters or exits the ultra-deep sleep state based on the movement speed of the UE.

In some embodiments, the movement speed of the UE may be an actual movement speed of the UE, or may be determined by the number of cell reselections occurring within a specified time. The specified time and threshold depend on a network-side configuration.

For example, when the movement speed of the UE exceeds a certain threshold, exiting the ultra-deep sleep state is performed;
when the movement speed of the UE is less than a certain threshold, entering the ultra-deep sleep state is performed.

Alternatively, when a difference between the movement speed of the UE and an offset is greater than a certain threshold, exiting the ultra-deep sleep state is performed;
when a sum of the movement speed of the UE and the offset is less than a certain threshold, entering the ultra-deep sleep state is performed.

The offset depends on a network configuration.

The present disclosure further provides an apparatus for implementing any one of the above methods. For example, an apparatus is provided. The apparatus includes units or modules for implementing the steps performed by the terminal in any one of the above methods. As another example, another apparatus is provided. The apparatus includes units or modules for implementing the steps performed by a network device (e.g., an access network device, or a core network device) in any one of the above methods.

It should be understood that the division of units or modules in the above apparatus is only a logical functional division. In actual implementations, the units or modules may be fully or partially integrated into a physical entity, or the units or modules may be physically separated. Furthermore, the units or modules in the apparatus may be implemented in a form of a processor invoking software. For example, the apparatus includes a processor connected to a memory, and instructions are stored in the memory. The processor invokes the instructions stored in the memory to implement any one of the above methods or to implement the functions of the units or modules in the above apparatus. The processor may be, for example, a general-purpose processor, such as a Central Processing Unit (CPU) or a microprocessor, and the memory may be a memory within the apparatus, or a memory outside the apparatus. Alternatively, the units or modules in the apparatus may be implemented in a form of hardware circuit(s). The functions of a part or all of the units or modules may be implemented through a design of the hardware circuit(s). The hardware circuit(s) may be understood as one or more processors. For example, in an implementation, the hardware circuit is an Application-Specific Integrated Circuit (ASIC), and the functions of a part or all of the units or modules can be implemented through the design of a logical relationship between components within the circuit. In another implementation, the hardware circuit may be implemented using a Programmable Logic Device (PLD), such as a Field-Programmable Gate Array (FPGA), which may include a large number of logic gate circuits. A connection relationship between the logic gate circuits is configured through a configuration file, achieving the functions of a part or all of the units or modules. All units or modules of the apparatus may be implemented entirely through the form of processor invoking software, or may be implemented entirely through the form of hardware circuit(s), or may be implemented partially through the form of processor invoking software, with the remaining part implemented through the form of hardware circuit(s).

In an embodiment of the present disclosure, the processor is a circuit with signal processing capabilities. In an implementation, the processor may be a circuit with instruction read and execution capabilities, such as a Central Processing Unit (CPU), a microprocessor, a Graphics Processing Unit (GPU) (which may be understood as a microprocessor), or a Digital Signal Processor (DSP), etc. In another implementation, the processor may implement certain functions through a logical relationship between hardware circuits. The logical relationship between the hardware circuits is fixed or reconfigurable. For example, the processor is a hardware circuit implemented using an Application-Specific Integrated Circuit (ASIC) or a Programmable Logic Device (PLD), such as an FPGA. In a reconfigurable hardware circuit, a procedure in which the processor loads a configuration file to realize the configuration of the hardware circuit can be understood as a procedure in which the processor loads instructions to implement the functions of a part or all of the above units or modules. Furthermore, it may also be a hardware circuit designed for artificial intelligence, which may be understood as an ASIC, such as a Neural Network Processing Unit (NPU), a Tensor Processing Unit (TPU), or a Deep learning Processing Unit (DPU), etc.

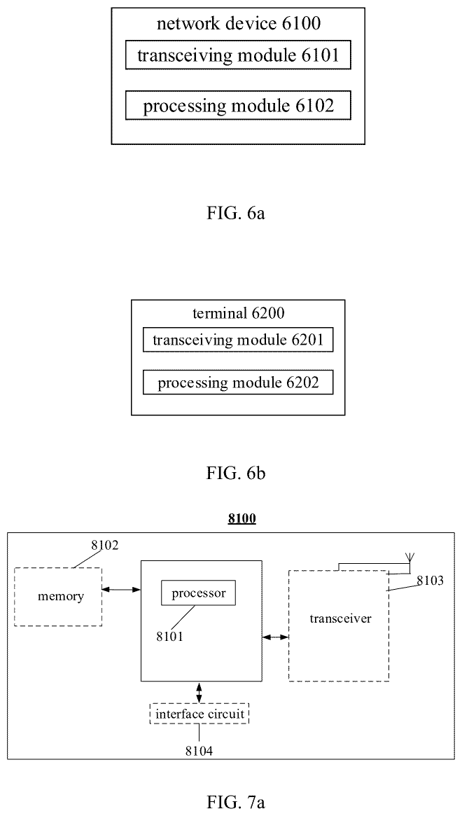

FIG. 6a is a schematic diagram of the structure of a network device provided in an embodiment of the present disclosure. As shown in FIG. 6a, the network device 6100 includes: a transceiving module 6101 and a processing module 6102. The transceiving module 6101 is configured to send and receive information. The processing module 6102 is configured to perform operation(s). Optionally, the transceiving module 6101 is configured to perform the steps related to sending of information performed by the network device 6100 in any one of the above communication methods, which will not be described in detail here. Optionally, the processing module 6102 performs the steps related to information processing performed by the network device in any one of the above communication methods, which will not be described in detail here.

FIG. 6b is a schematic diagram of the structure of a terminal provided in an embodiment of the present disclosure. As shown in FIG. 6b, the terminal 6200 includes: a transceiving module 6201 and a processing module 6202. The transceiving module 6201 is configured to receive information. The processing module 6202 is configured to perform operation(s). Optionally, the transceiving module 6201 is configured to perform the steps related to information reception performed by the terminal 6200 in any one of the above communication methods, which will not be described in detail here. Optionally, the processing module 6202 is configured to perform the steps related to information processing performed by the terminal in any one of the above communication methods, which will not be described in detail here.

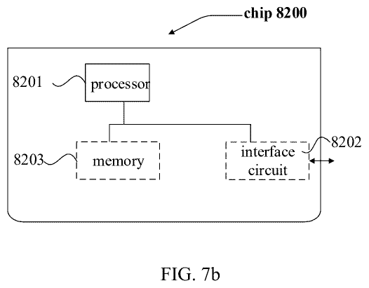

FIG. 7a is a schematic diagram of the structure of a communication device 8100 provided in an embodiment of the present disclosure. The communication device 8100 may be a network device (e.g., an access network device or a core network device, etc.), or may be a terminal (e.g., user equipment, etc.), or may be a chip, chip system, or processor, etc., that supports the network device in implementing any one of the above methods, or may be a chip, chip system, or processor, etc., that supports the terminal in implementing any one of the above information indication methods. The communication device 8100 can be configured to implement the information indication methods described in the above method embodiments; for details, reference may be made to the descriptions in the above method embodiments.

As shown in FIG. 7a, the communication device 8100 includes one or more processors 8101. The processor 8101 be a general-purpose processor or a dedicated processor, etc., such as a baseband processor or a central processor. The baseband processor may be used to process communication protocols and communication data, while the central processor may be used to control a communication apparatus (e.g., a base station, a baseband chip, a terminal device, a terminal device chip, a DU or a CU, etc.), execute programs, and process program data. The processor 8101 is used to invoke instructions to cause the communication device 8100 to perform any one of the above communication methods.

In some embodiments, the communication device 8100 further includes one or more memories 8102 for storing instructions. Optionally, all or part of the memories 8102 may also be located outside the communication device 8100.

In some embodiments, the communication device 8100 further includes one or more transceivers 8103. When the communication device 8100 includes one or more transceivers 8103, the communication steps such as sending and receiving in the above methods are performed by the transceivers 8103, and other steps are performed by the processor(s) 8101.

In some embodiments, the transceiver may include a receiver and a sender. The receiver and the sender may be separate or integrated. Optionally, the terms such as transceiver, transceiving unit, transceiving machine, transceiving circuit, etc., may be used interchangeably; terms such as sender, sending unit, sending machine, sending circuit, etc., may be used interchangeably; and terms such as receiver, receiving unit, receiving machine, receiving circuit, etc., may be used interchangeably.

Optionally, the communication device 8100 further includes one or more interface circuits 8104, which are connected to the memory 8102. The interface circuits 8104 may be used to receive signals from the memory 8102 or other device(s), and may be used to send signals to the memory 8102 or other device(s). For example, the interface circuits 8104 may read instructions stored in the memory 8102 and send the instructions to the processor 8101.

The communication device 8100 described in the above embodiments may be a network device or a terminal, but the scope of the communication device 8100 described in the present disclosure is not limited thereto, and the structure of the communication device 8100 may not be limited by FIG. 7a. The communication device may be a standalone device or a part of a larger device. For example, the communication device may be: (1) a standalone integrated circuit IC, or a chip, or a chip system or a subsystem; (2) a collection of one or more ICs, optionally, the IC collection may also include a storage component for storing data or programs; (3) an ASIC, such as a modem; (4) a module that may be embedded in other devices; (5) a receiver, a terminal device, a smart terminal device, a cellular phone, a wireless device, a handheld device, a mobile unit, a vehicle-mounted device, a network device, a cloud device, an artificial intelligence device, etc.; (6) others, etc.

FIG. 7b is a schematic diagram of the structure of a chip 8200 provided in an embodiment of the present disclosure. For a case where the communication device 8100 may be a chip or a chip system, reference may be made to the schematic diagram of the structure of chip 8200 shown in FIG. 7b, but the present disclosure is not limited to this.

The chip 8200 includes one or more processors 8201, which are used to invoke instructions to cause the chip 8200 to perform any one of the above communication methods.

In some embodiments, the chip 8200 further includes one or more interface circuits 8202 connected to a memory 8203. The interface circuits 8202 may be used to receive signals from the memory 8203 or other device(s), and may also be used to send signals to the memory 8203 or other device(s). For example, the interface circuits 8202 may read instructions stored in the memory 8203 and send the instructions to the processor(s) 8201. Optionally, terms such as interface circuit, interface, transceiving pin, transceiver, etc., may be used interchangeably.

In some embodiments, the chip 8200 further includes one or more memories 8203 for storing instructions. Optionally, all or part of the memories 8203 may be located outside of the chip 8200.

The present disclosure further provides a storage medium storing instructions. When the instructions run on the communication device 8100, the communication device 8100 is caused to perform any one of the methods described above. Optionally, the storage medium is an electronic storage medium. Optionally, the storage medium is a computer-readable storage medium, but it may also be a storage medium readable by other device(s). Optionally, the storage medium may be a non-transitory storage medium, but it may also be a transitory storage medium.

The present disclosure further provides a program product. When the program product is executed by the communication device 8100, the communication device 8100 is caused to perform any one of the above communication methods. Optionally, the program product is a computer program product.

The present disclosure also provides a computer program. When the computer program runs on a computer, the computer is caused to perform any one of the above communication methods.

Other embodiments of the present disclosure will be apparent to those skilled in the art from consideration of the specification and practice of the disclosure disclosed here. The present disclosure is intended to cover any variations, uses, or adaptations of the present disclosure following the general principles thereof and including such departures from the present disclosure as come within known or customary practice in the art. It is intended that the specification and embodiments be considered as illustrative only, with a true scope and spirit of the present disclosure being indicated by the following claims.

It should be appreciated that the present disclosure is not limited to the exact construction that has been described above and illustrated in the accompanying drawings, and that various modifications and changes can be made without departing from the scope thereof. It is intended that the scope of the present disclosure only be limited by the appended claims.

1. A communication method, performed by a terminal, the method comprising:
after a first receiver of the terminal enters or exits a first state, performing a first operation for the first receiver according to a first type condition;
wherein the first state is a sleep state of the first receiver;
wherein the first type condition comprises at least one of: a condition in which a determination is made based on a retention duration, a condition in which a determination is made based on a signal quality, or a condition in which a determination is made based on a movement speed of the terminal;
wherein the first operation comprise one of: entering the first state or exiting the first state.

2. The method according to claim 1, wherein before performing the first operation for the first receiver according to the first type condition, the method further comprises:
determining whether the first receiver enters or exits the first state according to a second type condition;
wherein the second type condition comprises at least one of:
a condition in which a determination is made based on a signal quality; or
a condition in which a determination is made based on a movement speed of the terminal.

3. The method according to claim 1, wherein performing the first operation for the first receiver according to the first type condition comprises: enabling the first receiver to exit the first state after the first receiver maintains the first state for at least a first duration after entering the first state; or
wherein performing the first operation for the first receiver according to the first type condition comprises: enabling the first receiver to enter the first state after the first receiver maintains out of the first state for at least a second duration after exiting the first state.

4. The method according to claim 3, wherein enabling the first receiver to exit the first state after the first receiver maintains for at least the first duration after entering the first state comprises:
after the first receiver enters the first state, maintaining the first state for at least the first duration, and determining that a signal quality of a reference signal received by the terminal is less than or equal to a first signal quality threshold, exiting the first state; or
after the first receiver enters the first state, maintaining the first state for at least the first duration, and determining that a sum of the signal quality of the reference signal received by the terminal and a first hysteresis is less than or equal to the first signal quality threshold, exiting the first state; or
wherein enabling the first receiver to enter the first state after the first receiver maintains out of the first state for at least the second duration after exiting the first state comprises:
after the first receiver exits the first state, maintaining out of the first the first state for at least the second duration, and determining that a signal quality of a reference signal received by the terminal is greater than or equal to a second signal quality threshold, entering the first state; or
after the first receiver exits the first state, maintaining out of the first state for at least the second duration, and determining that a difference between the signal quality of the reference signal received by the terminal and a second hysteresis is greater than or equal to the second signal quality threshold, entering the first state.

5. (canceled)

6. (canceled)

7. The method according to claim 1, wherein performing the first operation for the first receiver according to the first type condition comprises:
after the first receiver enters the first state, within a third duration, determining that a signal quality of a reference signal received by the terminal is less than or equal to a third signal quality threshold, exiting the first state; or
after the first receiver enters the first state, within the third duration, determining that a sum of the signal quality of the reference signal received by the terminal and a third hysteresis is less than or equal to the third signal quality threshold, exiting the first state.

8. The method according to claim 7, wherein performing the first operation for the first receiver according to the first type condition comprises:
after the first receiver enters the first state, maintaining the state unchanged after the third duration; determining that the signal quality of the reference signal received by the terminal is less than or equal to a fourth signal quality threshold, exiting the first state; or
after the first receiver enters the first state, maintaining the state unchanged after the third duration; determining that a sum of the signal quality of the reference signal received by the terminal and a fourth hysteresis is less than or equal to the fourth signal quality threshold, exiting the first state;
wherein the third signal quality threshold and the fourth signal quality threshold are different; and/or, values of the third hysteresis and the fourth hysteresis are different.

9. (canceled)

10. The method according to claim 1, wherein performing the first operation for the first receiver according to the first type condition comprises:
after the first receiver exits the first state, within a fourth duration, determining that a signal quality of a reference signal received by the terminal is greater than or equal to a fifth signal quality threshold, entering the first state; or
after the first receiver exits the first state, within the fourth duration, determining that a difference between the signal quality of the reference signal received by the terminal and a fifth hysteresis is greater than or equal to a fifth signal quality threshold, entering the first state.

11. The method according to claim 10, wherein performing the first operation for the first receiver according to the first type condition comprises:
after the first receiver exits the first state, maintaining the state unchanged after the fourth duration; determining that the signal quality of the reference signal received by the terminal is greater than or equal to a sixth signal quality threshold, entering the first state; or
after the first receiver exits the first state, maintaining the state unchanged after the fourth duration; determining that a difference between the signal quality of the reference signal received by the terminal and a sixth hysteresis is greater than or equal to the sixth signal quality threshold, entering the first state;
wherein the fifth signal quality threshold and the sixth signal threshold are different; and/or, values of the fifth hysteresis and the sixth hysteresis are different.

12. (canceled)

13. (canceled)

14. The method according to claim 1, wherein performing the first operation for the first receiver according to the first type condition comprises:
after the first receiver enters the first state, within a fifth duration, determining that the movement speed of the terminal is greater than or equal to a first speed threshold, exiting the first state; or
after the first receiver enters the first state, within the fifth duration, determining that a difference between the movement speed of the terminal and a first offset value is greater than or equal to the first speed threshold, exiting the first state.

15. The method according to claim 14, wherein performing the first operation for the first receiver according to the first type condition comprises:
after the first receiver enters the first state, maintaining the state unchanged after the fifth duration; determining that the movement speed of the terminal is greater than or equal to a second speed threshold, exiting the first state; or
after the first receiver enters the first state, maintaining the state unchanged after the fifth duration; determining that a difference between the movement speed of the terminal and a second offset value is greater than or equal to a second speed threshold, exiting the first state;
wherein the first speed threshold and the second threshold are different; and/or, the first offset value and the second offset value are different.

16. (canceled)

17. The method according to claim 1, wherein performing the first operation for the first receiver according to the first type condition comprises:
after the first receiver exits the first state, within a sixth duration, determining that the movement speed of the terminal is less than or equal to a third speed threshold, entering the first state; or
after the first receiver exits the first state, within the sixth duration, determining that a sum of the movement speed of the terminal and a third offset value is less than or equal to a third speed threshold, entering the first state.

18. The method according to claim 17, wherein performing the first operation for the first receiver according to the first type condition comprises:
after the first receiver exits the first state, maintaining the state unchanged after the sixth duration; determining that the movement speed of the terminal is less than or equal to a fourth speed threshold, entering the first state; or
after the first receiver exits the first state, maintaining the state unchanged after the sixth duration; determining that a sum of the movement speed of the terminal and a fourth offset value is less than or equal to a fourth speed threshold, entering the first state;
wherein the third speed threshold and the fourth speed threshold are different; and/or, the third offset value and the fourth offset value are different.

19. (canceled)

20. (canceled)

21. The method according to claim 3, further comprising:
in response to the number of times of entering and exiting the first state within a first period being greater than or equal to a first quantity, increasing a predetermined duration;
wherein the predetermined duration comprises at least one of: the first duration, the second duration, the third duration, the fourth duration, the fifth duration, and the sixth duration.

22. The method according to claim 1, further comprising:
the first receiver being not in the first state, performing a second operation;
or, the first receiver being in the first state, stopping performing the second operation or turning off an active device;
wherein the second operation comprises at least one of:
monitoring a downlink (DL) channel;
receiving the downlink (DL) channel;
sending an uplink (UL) signal; or
send uplink (UL) data.

23. The method according to claim 4, wherein the reference signal is one of:
a first signal that is a signal received by the first receiver;
a second signal that is a signal received by a second receiver.

24. The method according to claim 23, further comprising:
receiving fourth information sent by a network device;
wherein the fourth information indicates that the reference signal is the first signal or the second signal.

25. The method according to claim 23, wherein the first signal is a synchronization signal block SSB, and the second signal is a Low Power Synchronization Signal (LP-SS).

26. The method according to any one of claim 1, further comprising:
receiving fifth information sent by a network device;
wherein the fifth information comprises at least one of: LP-SS configuration information; LP-WUS configuration information;
wherein receiving the fifth information sent by the network device comprises:
receiving a system message sent by the network device, wherein the system message comprises the fifth information.

27. (canceled)

28. The method according to claim 26, wherein the fifth information comprises at least one of:
information about a Frequency Range (FR);
duty cycle information for monitoring the LP-WUS;
a time-domain resource and/or a frequency-domain resource for monitoring the LP-WUS;
a scramble code for addressing the terminal;
a validity area or a timer for the LP-WUS configuration;
a specific Radio Network Temporary Identifier (RNTI) for LP-WUS activation or deactivation;
a waveform for the LP-WUS;
configuration information for beam sweeping for LP-WUS transmission;
a frequency offset between the first receiver and a second receiver of the terminal;
downlink (DL) timing offset between the first receiver and the second receiver.

29. (canceled)

30. A communication apparatus, comprising:
a memory comprising executable instructions;
one or more processors;
wherein when the executable instructions are executed by the processors, the communication apparatus is caused to:
after a first receiver of the terminal enters or exits a first state, perform a first operation for the first receiver according to a first type condition;
wherein the first state is a sleep state of the first receiver;
wherein the first type condition comprises at least one of: a condition in which a determination is made based on a retention duration, a condition in which a determination is made based on a signal quality, or a condition in which a determination is made based on a movement speed of the terminal;
wherein the first operation comprise one of: entering the first state or exiting the first state.

31. (canceled)
